(19) United States
(12) Patent Application Publication
(10) Pub. No.: US 2011/0005091 A1
(43) Pub. Date: Jan. 13, 2011

(54) Level lite

(76) Inventor: Dale A. Pedersen, Blanchardville, WI (US)

Correspondence Address: RUTH EURE, 4795 EDISON AVENUE, BOULDER, CO, 80301, US

(21) Appl. No.: 12/803,537

(22) Filed: Jun. 29, 2010

Related U.S. Application Data
(60) Provisional application No. 61/269,792, filed on Jun. 29, 2009.

(51) Int. Cl. G01C 9/32; F21L 4/08

(52) U.S. Cl. 33/348.2; 362/183

(57) ABSTRACT

As the name implies, this product is a compact leveling device that is configured with a series of lighting fixtures. Similar in construction to standard levels, the Level Lite is fabricated of durable metal or plastic material. A solid level, this product is available in various sizes. A series of light emitting diodes (LED) are evenly spaced apart within the circular opening of the unit which houses the liquid filled vial, providing illumination for the entire unit while in use. Power to the Level Lite is provided by an internally encased, replaceable battery, such as a standard AA alkaline battery, or coin battery. Additional contemplated power sources include solar cells and rechargeable batteries.

### CLAIM OF PRIORITY

This patent application claims priority under 35 USC 119 (e) (1) from U.S. Provisional Patent Application Ser. No. 61/269,792 filed Jun. 29, 2009, of Dale A. Pedersen entitled, “Pedersen Level Lite.”

### FIELD OF THE INVENTION

The present invention pertains to the field of construction tools, more specifically to the field of carpentry tools, and more particularly to the field of levels and even more specifically to the field of illuminated levels.

### BACKGROUND OF THE INVENTION

The prior art has put forth several designs for illuminated levels. Among these are:

U.S. Pat. D301,553 shows an illuminated level to Ben Makofsky. This is a design patent which covers the appearance of the device.

U.S. Pat. No. 4,407,075 to Carl H. MacDermott and Richard S. Brown, Jr. describes an illuminated spirit vial and level which comprises illumination at the ends of the spirit vial which illuminates the bubble in the spirit vial.

U.S. Pat. No. 4,392,184 to Own E. Hearold and Harvey G. Bennett describes an illuminating method and apparatus for illuminating carpenter's and mechanic's levels.

None of these prior art references describe the present invention.

### SUMMARY OF THE INVENTION

It is an object of the present invention to provide an improved illuminated level.

It is an object of the present invention to provide an improved illuminated level which is powered by solar cells.

It is an object of the present invention to provide an improved illuminated level which is powered by rechargeable batteries.

### BRIEF DESCRIPTION OF THE INVENTION

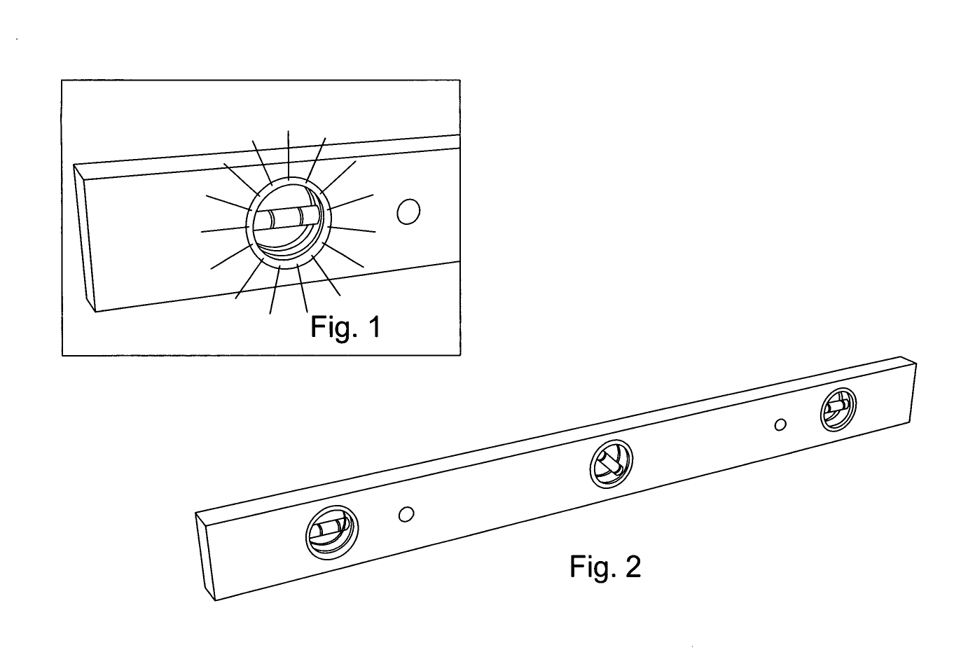

FIG. 1 shows a close up view of the illumination of the circle of the level of the present invention.

FIG. 2 is a perspective view of the level of the present invention.

### DETAILED DESCRIPTION OF THE INVENTION

The vast majority of home improvement or repair jobs cannot be completed without the proper tools. In fact, it is not uncommon to find a fully stocked tool box or chest in the garages, sheds, and utility closets. Along with screwdrivers, wrenches, and pliers, a staple of many tool boxes is a leveling instrument. The purpose of the level is to ascertain whether a surface is horizontal, vertical, or at a 45° angle.

Consisting essentially of an encased, liquid-filled tube containing an air bubble that moves to a center window when the instrument is set on an even plane, this instrument measures true horizontal (level) and true vertical (plumb). The tube, or vial, is incorporated into rails of wood, plastic, aluminum or magnesium, offered in solid, I-beam or box-beam. Helping to assure straight, even placements and level, smooth edges, the level is an essential tool in many home improvement projects, helping to ensure that the job is done right.

Recognizing the potential for an enhancement to existing levels that would render these devices easier to use, especially in dark environments, the present invention, hereinafter referred to as the Level Lite was developed. As the name implies, this product is a compact leveling device that is configured with a series of lighting fixtures. Similar in construction to standard levels, the Level Lite is fabricated of durable metal or plastic material. A solid level, this product is available in various sizes. These include: lengths of approximately 6 inches, 12 inches, 2 feet, 4 feet, 6 feet and 8 feet; width of approximately 2.25 inches; and depth of approximately 1.25 inches. The exterior of the unit features a length of magnetic strip to facilitate placement of the unit. In addition, a sliding on/off switch is located on the top panel of the unit. The unique components of the Level Lite are found in its interior. A series of light emitting diodes (LED) are evenly spaced apart within the circular opening of the unit which houses the liquid filled vial, providing illumination for the entire unit while in use. Power to the Level Lite is provided by an internally encased, replaceable battery, such as a standard AA alkaline battery, or coin battery. Additional contemplated power sources include solar cells and rechargeable batteries.

Use of the Level Lite is very simple and straightforward. First, the surface to be leveled should be straight so the level will not rock. Next, the light button is pressed, emitting a glow that renders the tool completely visible. Placing the magnetic side of Level Lite in the center of the job, or the surface to be leveled, the user slowly adjusts one end of the work until the vial (or digital readout on electronic models) conveys the level angle. In this manner, the Level Lite better enables the user to determine that the item is on a straight plane, even in the worst light. When finished, or between leveling jobs, the user can simply slip the unit into a pocket, where it is readily accessible when needed again.

There are several significant benefits and advantages associated with this clever product invention. Foremost, the Level Lite provides a more user-friendly means of achieving straight planes in virtually any leveling job. A level that is specially configured with lighting capabilities, this handy product offers an easily seen, illuminated indication that an item is level. In this manner, the Level Lite eliminates the need to juggle an unwieldy flashlight when working in darkened areas such as basements, attics, crawl spaces, or simply in bad lighting.

In addition, consumers avoid eye strain staring at the rising or falling liquid while adjusting the level. This ease of use offered by the Level Lite helps make many home repair and improvement jobs a snap for even the most inexperienced handyman or woman. While this product was primarily conceived with household users in mind, professional contractors, electricians, plumbers, and carpenters appreciate the benefits afforded by this timesaving device. Made of durable, high quality materials, the Level Lite will withstand years of continued use.

An innovative invention, the Level Lite readily enhances the do-it-yourself experience. Compact and lightweight, this handy device proves an invaluable addition to any tool box or utility drawer.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An improved illuminated level, comprising: an elongate level comprising an encased, liquid-filled tube or vial containing an air bubble that moves to a center window when the level is set on an even plane, measures true horizontal (level) and true vertical (plumb), and wherein the tube or vial, is incorporated into wood, plastic, aluminum or magnesium, offered in solid, I-beam or box-beam; wherein the improvement comprises a multiplicity of light emitting diodes (LED) evenly spaced apart within the circular opening of the unit which houses the liquid filled vial, providing illumination for the entire unit while in use.

2. The improved illuminated level of claim 1 wherein the illumination source is powered by solar cells.

3. The improved illuminated level of claim 1 wherein the illumination source is powered by rechargeable batteries.

4. The improved illuminated level of claim 1 wherein the level is fabricated of durable metal or plastic material.

5. The level of claim 1 which is approximately 6 inches in length.

6. The level of claim 1 which is approximately 12 inches in length.

7. The level of claim 1 which is approximately 2 feet in length.

8. The level of claim 1 which is approximately 4 feet in length.

9. The level of claim 1 which is approximately 6 feet in length.

10. The level of claim 1 which is approximately 8 feet in length.

11. The level of claim 1 further including a length of magnetic strip to facilitate placement of the unit.

12. The level of claim 1 further including a sliding on/off switch located on the top of the level.

13. The improved illuminated level of claim 1 wherein the illumination source is powered by a standard AA alkaline battery.
